(19) United States
(12) Patent Application Publication
(10) Pub. No.: US 2014/0242715 A1
(43) Pub. Date: Aug. 28, 2014

(54) Detection of Volatiles in Personal Care Products

(71) Applicant: KIMBERLY-CLARK WORLDWIDE, INC., Neenah, WI (US)

(72) Inventors: Davis-Dang Hoang Nhan, Appleton, WI (US); Sridhar Ranganathan, Suwanee, GA (US); JunMo Gil, Dae-Jeon (KR); Xuedong Song, Alpharetta, GA (US)

(73) Assignee: KIMBERLY-CLARK WORLDWIDE, INC., Neenah, WI (US)

(21) Appl. No.: 13/780,950

(22) Filed: Feb. 28, 2013

(51) Int. Cl. G01N 21/78

(52) U.S. Cl. CPC G01N 21/78
USPC 436/164

(57) ABSTRACT

Color-change compositions for detecting urine and feces volatiles include the following pH indicator dyes: m-Cresol Purple, Basic Fuchsin, Brilliant Blue G, Brilliant Blue R, Cresol Red and Thymol Blue. The compositions may be applied to various substrates. Such substrates may be used in the construction of a personal care absorbent article such as a diaper, training pant or incontinence garment.

The present disclosure relates to color-changing compositions that can change color in the presence of urine and feces volatiles in absorbent personal care products such as diapers and incontinence products.

### BACKGROUND

Disposable absorbent articles such as diapers, training pants, incontinence pads, and the like are highly absorbent and efficiently pull moisture away from the wearer, thereby reducing skin irritation caused by prolonged wetness exposure. Despite successes in drawing moisture away from the wearer's skin, available absorbent articles cannot absorb solid fecal matter in the same way. Therefore, wearers of disposable absorbent articles who cannot communicate the need for a change may experience longer exposure to feces than with urine. Prolonged contact with fecal matter can be irritating to the skin. In addition, embarrassing odor may be emitted from the absorbent article before it is noted that a change is needed.

While there are many wetness-detecting compositions that may be used in absorbent articles, in particular those that detect a change in pH, there are very few compositions that can detect volatiles. Known compositions can detect ammonia, carbon dioxide, amine and carboxylic acid volatiles. These detectors may be used to detect urine (ammonia) and food spoilage, but none can detect feces volatiles.

A need exists for a urine and feces volatile-sensing composition that is cost effective and reliable. A personal hygiene article, in particular an absorbent article, incorporating such a composition would be beneficial.

### SUMMARY

In one aspect of the disclosure is a color-change composition for the detection of urine or feces volatiles. The composition includes a dye selected from m-Cresol Purple, Basic Fuchsin, Brilliant Blue G, Brilliant Blue R, Cresol Red and Thymol Blue, and combinations thereof; a film former; and a solvent. The dye is 0.01% to 10% of the total weight of the composition, and the film former is 3% to 50% of the total weight of the composition.

In another aspect of the disclosure is an absorbent article for detecting volatiles from human waste. The article has an absorbent core disposed between a topsheet and a backsheet, and a color-change composition disposed on a body-facing surface of the backsheet. The color change composition includes a dye selected from m-Cresol Purple, Basic Fuchsin, Brilliant Blue G, Brilliant Blue R, Cresol Red and Thymol Blue, and combinations thereof; a film former; and a pH adjuster.

In yet another aspect of the disclosure is a substrate for detecting urine or feces volatiles. The substrate is a sheet or web with a color-change composition disposed thereon. The composition includes a dye selected from m-Cresol Purple, Basic Fuchsin, Brilliant Blue G, Brilliant Blue R, Cresol Red and Thymol Blue, and combinations thereof; and a film former.

### BRIEF DESCRIPTION OF THE DRAWINGS

The foregoing and other features and aspects of the present invention and the manner of attaining them will become more apparent, and the invention itself will be better understood by reference to the following description, appended claims and accompanying drawings, where:

FIG. 1 is a front perspective view of one embodiment of an absorbent article;

FIG. 2 is a plan view of the absorbent article of FIG. 1, as unfastened, unfolded, and laid out flat;

FIG. 3 is are color photographs showing the color change of various dyes according to the present disclosure;

FIG. 4 is a chart showing concentration of volatiles versus ΔE;

FIG. 5 is a chart showing concentration of volatiles versus response time;

FIG. 6 is a depiction of a gas chamber used for testing;

FIG. 7 is a schematic drawing of CIELAB color coordinates; and

FIG. 8 is one embodiment of a substrate that includes the color-change composition of the present disclosure.

### DETAILED DESCRIPTION

“Nonwoven” and “nonwoven web” refer to materials and webs of material that are formed without the aid of a textile weaving or knitting process. For example, nonwoven materials, fabrics or webs have been formed from many processes such as, for example, meltblowing processes, spunbonding processes, air laying processes, coform processes, and bonded carded web processes.

“Coform” refers to a blend of meltblown fibers and absorbent fibers such as cellulosic fibers that can be formed by air forming a meltblown polymer material while simultaneously blowing air-suspended fibers into the stream of meltblown fibers. The meltblown fibers and absorbent fibers are collected on a forming surface, such as provided by a belt. Two U.S. patents describing coform materials are U.S. Pat. No. 5,100,324 to Anderson et al. and U.S. Pat. No. 5,350,624 to Georger et al., both of which are incorporated in their entirety in a manner consistent herewith.

“Meltblown” refers to fibers formed by extruding a molten thermoplastic material through a plurality of fine, usually circular, die capillaries as molten threads or filaments into converging high velocity gas (e.g., air) streams, generally heated, which attenuate the filaments of molten thermoplastic material to reduce their diameters. Thereafter, the meltblown fibers are carried by the high velocity gas stream and are deposited on a collecting surface or support to form a web of randomly dispersed meltblown fibers. Such a process is disclosed, for example, in U.S. Pat. No. 3,849,241 to Butin et al. which is incorporated in their entirety in a manner consistent herewith.

“Spunbonded fibers” refers to small diameter fibers which are formed by extruding molten thermoplastic material as filaments from a plurality of fine, usually circular capillaries of a spinneret with the diameter of the extruded filaments then being rapidly reduced to fibers as by, for example, in U.S. Pat. No. 4,340,563 to Appel et al.; U.S. Pat. No. 3,692,618 to Dorschner et al.; U.S. Pat. No. 3,802,817 to Matsuki et al.; U.S. Pat. Nos. 3,338,992 and 3,341,394 to Kinney; U.S. Pat. No. 3,502,763 to Hartman; and U.S. Pat. No. 3,542,615 to Dobo et al., the contents of which are incorporated herein by reference in their entirety in a manner consistent herewith. It is to be understood by one of ordinary skill in the art that the present discussion is a description of exemplary aspects of the present invention only, and is not intended as limiting the broader aspects of the present invention.

It is to be understood by one of ordinary skill in the art that the present discussion is a description of exemplary aspects of the present invention only, and is not intended as limiting the broader aspects of the present invention.

The present disclosure is generally directed to a color-change composition that can be applied to a surface of an absorbent article (e.g. diaper), wherein the composition is capable of detecting volatiles from urine and feces. An absorbent article including the composition provides several advantages over absorbent articles that include compositions which only detect liquid insults. One advantage, due to the almost immediate recognition of non-runny fecal matter, is less skin irritation from contact with feces. Another advantage is the detection of feces before it becomes obvious to those near the user of the absorbent article.

Desired characteristics of the color-change compositions of the present disclosure include being sensitive, selective, and stable. A composition is adequately sensitive when it changes color in the presence of urine or feces volatiles, or more specifically, when it changes color in response to 50 ppm of acetic acid volatiles in less than about 10 minutes.

Suitable color-change compositions having the desired characteristics include the following pH indicator dyes: m-Cresol Purple, Basic Fuchsin, Brilliant Blue G, Brilliant Blue R, Cresol Red and Thymol Blue. While there are many color-change compositions available for the detection of liquid feces or urine, bench testing has shown only these few compositions are suitable for detecting volatiles at the levels typically associated with urine and feces in an absorbent garment.

The color-change composition is applied to a substrate. The substrates can be porous and hydrophobic films and sheet materials, or cellulosic-based substrates such as fiber fluff, paper tissues, and paper sheets. The substrates can also be nonporous plastic films and sheets, such as polyolefin films, or nonwoven materials. Examples of polyolefin films include polyethylene and polypropylene films, or modified polyethylene and polypropylene films. The substrates may be a part of an outer cover of an absorbent article such as a diaper or adult incontinence article. In most applications, feces volatiles need to travel through the absorptive materials of an absorbent article (e.g. diaper or training pant) to reach the location of the color-change composition, which may be the inside surface of the outer cover. The outer cover and other various components of an exemplary absorbent article are described in detail below.

### (A)

### Composition of the Present Disclosure

Desirably, the color-change compositions of the present disclosure are applied to a substrate in the form of an ink. The ink can be readily applied into manufacturing processes because it involves a single-phase ink that can be directly applied in a single layer forming a film on the substrate.

The ink can be applied to the substrate by direct printing or spraying methods. The ink can be applied generally over an entire substrate surface or at discrete localized spots on the substrate. Further, the ink can be applied as a coating either in a mono-chromic color scheme alone, a bi-chromic color-scheme, or in a multiple color scheme. It is printed in various shaped and sized graphics of patterns, or in various alpha numeric symbols and/or words, or combinations thereof.

In one aspect of the disclosure, to prepare the ink, a pH-sensing dye, is combined with a film former (“binder”), a pH adjuster, a surfactant and a solvent. The various ink components are described below.

### Dye

Short chain fatty-acids have been identified as the main component of feces volatiles. These acidic volatiles may be detected with a basic color-change composition. Different compositions have different transition pH's where a color change occurs.

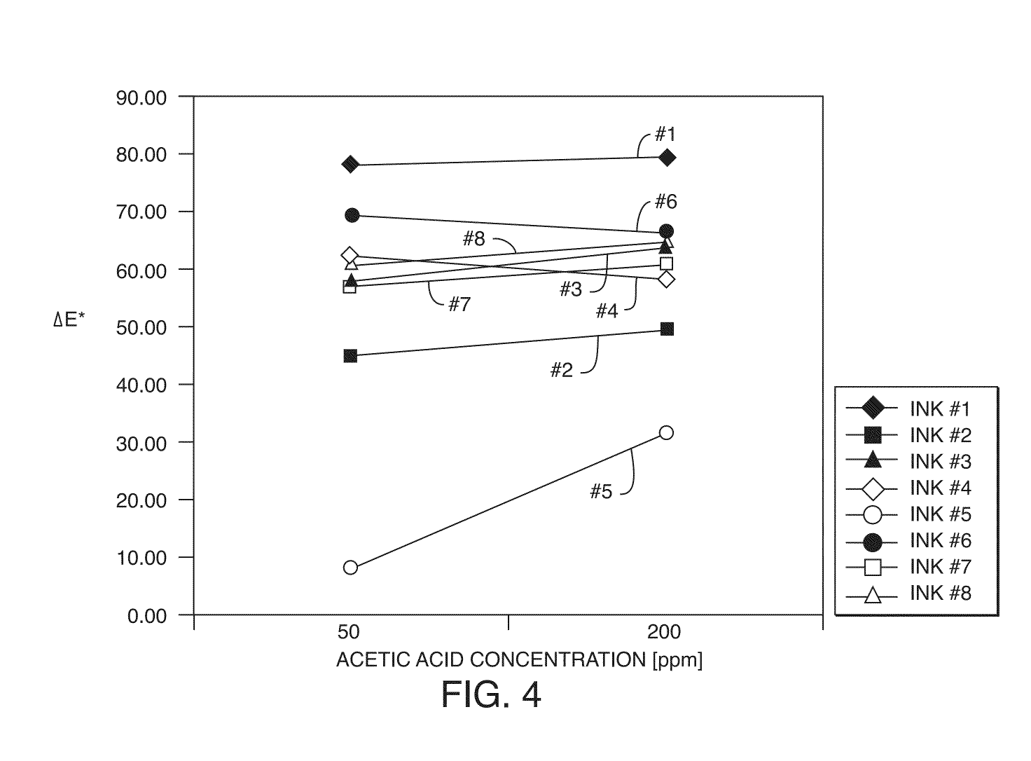

In one aspect of the disclosure, the purpose of the dye is to provide a visual signal when the pH has changed from a basic state to an acidic state in the presence of feces volatiles. As mentioned, suitable dyes include: m-Cresol Purple, Basic Fuchsin, Brilliant Blue G, Brilliant Blue R, Cresol Red and Thymol Blue. Each of these dyes demonstrate a change in color intensity (ΔE), after ten minutes of exposure to 50 ppm of a short-chain fatty acid (propionic or acetic), of about 10 to about 80 as seen in FIG. 4.

The amount if dye present in the color-change composition is about 0.01% to about 10%, or about 0.1% to about 2%, or about 0.2% to about 0.5% of the total weight of the composition.

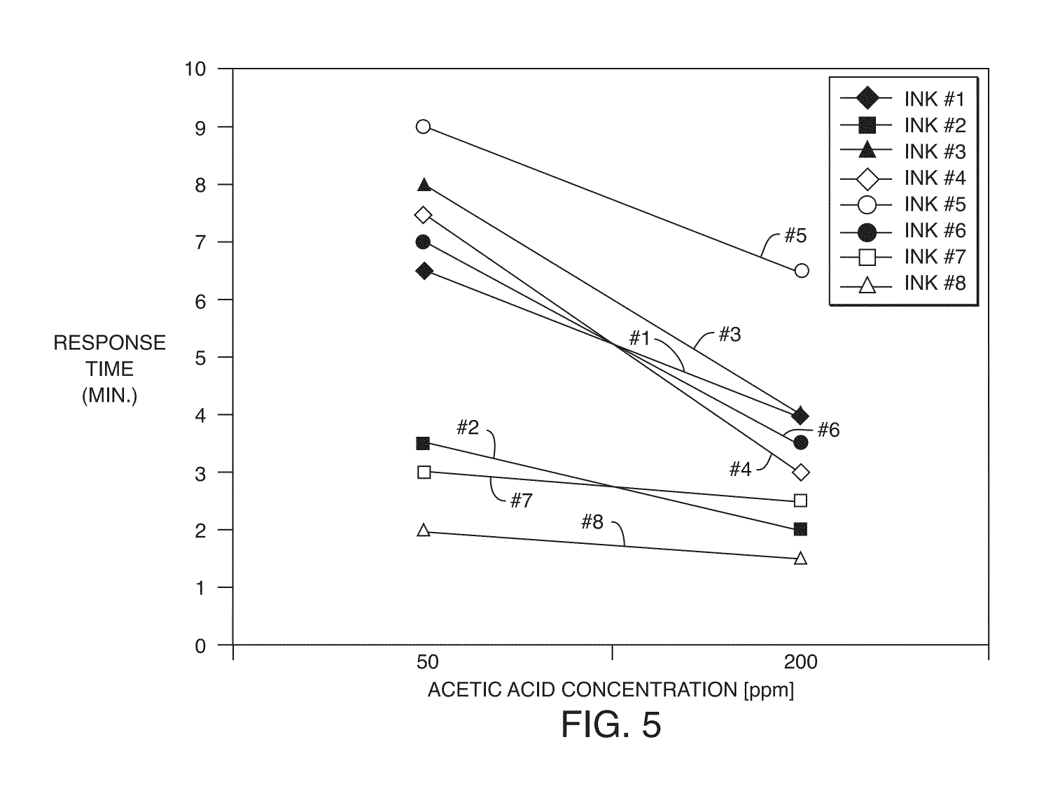

The response time for m-Cresol Purple, Basic Fuchsin, Brilliant Blue G, Cresol Red and Thymol Blue to achieve a visible signal ranged from about 3.5 to about 8 minutes. See FIG. 5.

### Film Former (Binder)

The purpose of film formers is to bind the other ingredients of the ink together so that it forms a film on a substrate. The film former can provide water resistance, minimizing leaching of the dye when contacted with an aqueous solution. It can also maintain or possibly improve the response time and color-change intensity of the ink when exposed to acid volatiles. Suitable film formers include vinyl acetate/ethylene copolymer dispersions (ex: VINNAPAS EZ123 available from Wacker Chemical Corporation, PA, USA), cationic polymers (ex: LUVIQUAT SUPREME available from BASF Corporation, NJ, USA), polyvinyl butyral resin (ex: BUTVAR B-79 available from Solutia Inc., MO, USA), polyamide resins (for example: Versamid 750 available from BASF Corporation, NJ, USA), carboxylated acrylic copolymer (ex: Dermacryl 79 AkzoNobel, Bridgewater, N.J., USA).

### pH Adjuster

The amount if film former present in the color-change composition is about 3% to about 50%, or about 4% to about 40%, or about 5% to about 30%, or about 6% to about 20%, or about 10% to about 15% of the total weight of the composition.

The purpose of the pH adjuster is to control the pH of the pH triggered color-changing compositions. The pH adjuster is a base or a combination of acid and base, such as would be found with a buffering composition. The pH adjuster is selected in conjunction with the choice of dye to be used in the color-changing composition and the substrate onto which the color-change composition is to be applied.

Suitable pH adjusters are inorganic bases. Examples of inorganic bases are: sodium hydroxide, potassium hydroxide, sodium carbonate, sodium bicarbonate, sodium borate. Examples of organic bases are: tetralbutylammonium hydroxide, benzyltrimethylammonium hydroxide, Choline base, Diethyldimethylammonium hydroxide, Dimethyldodecylethylammonium hydroxide, N,N,N,N′,N′,N′-Hexabutylhexamethylenediammonium dihydroxide, Hexadecyltrimethylammonium hydroxide, Hexamethonium hydroxide, Tetrabutylammonium ethoxide, Tetrabutylphosphonium hydroxide, Tetrahexylammonium hydroxide, Tetramethylammonium hydroxide, Tetraoctylammonium hydroxide, Tetrapropylammonium hydroxide, Tributylmethylammonium hydroxide, Trihexyltetradecylammonium hydroxide, Tetrabutylammonium methoxide and alkyl amide, polymeric amines, etc. The base is not limited on mentioned one if same mechanism applied for coloring phenomena. The base in the composition should not be a concern since the coloring film is not directly contact with skin and the slight basic condition can be neutralized in water/urine contact, indicated at the same time as color manifests.

The color-changing compositions of the invention include a pH adjuster in an amount of from about 1% to about 20% of the total weight of the color-changing ink composition. Desirably, the color-changing compositions of the invention include a pH adjuster in an amount of from about 2% to about 15%, or about 2% to about 10% of the total weight of the color-changing composition.

### Surfactant

The purpose of the surfactant is to adjust the surface tension of the ink. The surfactant may be ionic or non-ionic. The examples of non-ionic surfactants include alkyl poly(ethylene oxide) such as copolymers of poly(ethylene oxide) and poly(propylene oxide) (commercially called Poloxamers or Poloxamines), alkyl polyglucosides such as octyl glucoside and decyl maltoside, fatty alcohols such as cetyl alcohol, oleyl alcohol, cocamide MEA and cocamide DEA. The examples of ionic surfactants include anionic (e.g., based on sulfate, sulfonate or carboxylate anions) surfactants such as ammonium lauryl sulfate and other alkyl sulfate salts, Sodium laureth sulfate, also known as sodium lauryl ether sulfate, Alkyl benzene sulfonate, Soaps, or fatty acid salts; and Cationic (e.g., based on quaternary ammonium cations) surfactants such as Cetyl trimethylammonium bromide a.k.a. hexadecyl trimethyl ammonium bromide, and other alkyltrimethylammonium salts, Cetylpyridinium chloride, Polyethoxylated tallow amine, Benzalkonium chloride, Benzethonium chloride; or Zwitterionic (amphoteric) surfactants such as Dodecyl betaine, Dodecyl dimethylamine oxide, Cocamidopropyl betaine, Coco ampho glycinate. Alternatively, the wettability enhancing agents may also be hydrophilic molecules. The hydrophilic molecules may be small molecules such as sucrose, glucose and glycerol. The hydrophilic molecules may also be polymers such as polyethylene glycol and its copolymers.

### Solvent

The purpose of the solvent is to place the dye into a solution for ease of transferring during a printing process. Various polar or non-polar solvents may be used. The polar solvent can be either an aqueous or organic alcoholic medium.

### (B)

### Example of an Absorbent Article

In accordance with the present disclosure, one or more sensors described herein can also be integrated into an absorbent article. An “absorbent article” generally refers to any article capable of absorbing water or other fluids. Examples of some, absorbent articles include, but are not limited to, personal care absorbent articles, such as diapers, training pants, absorbent underpants, incontinence pants, disposable swim pants, and the like.

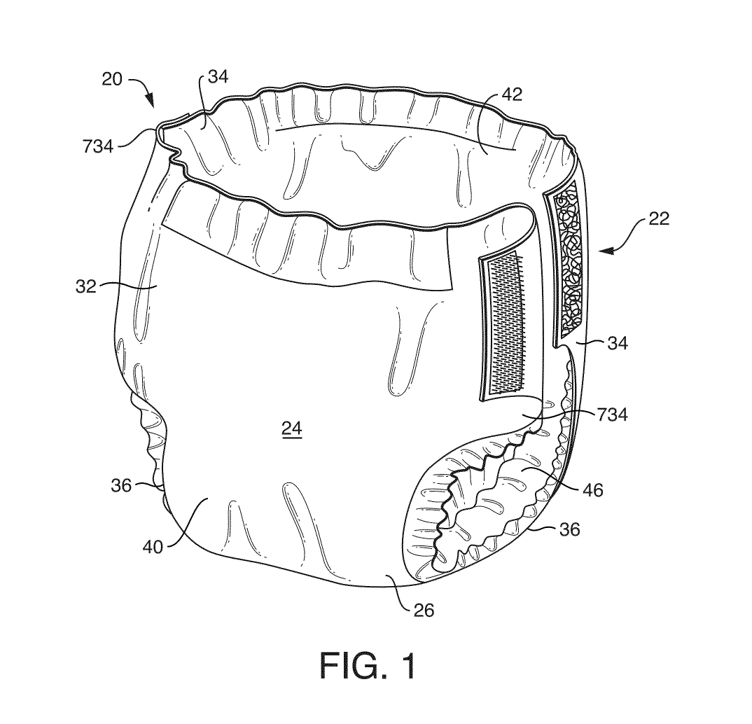

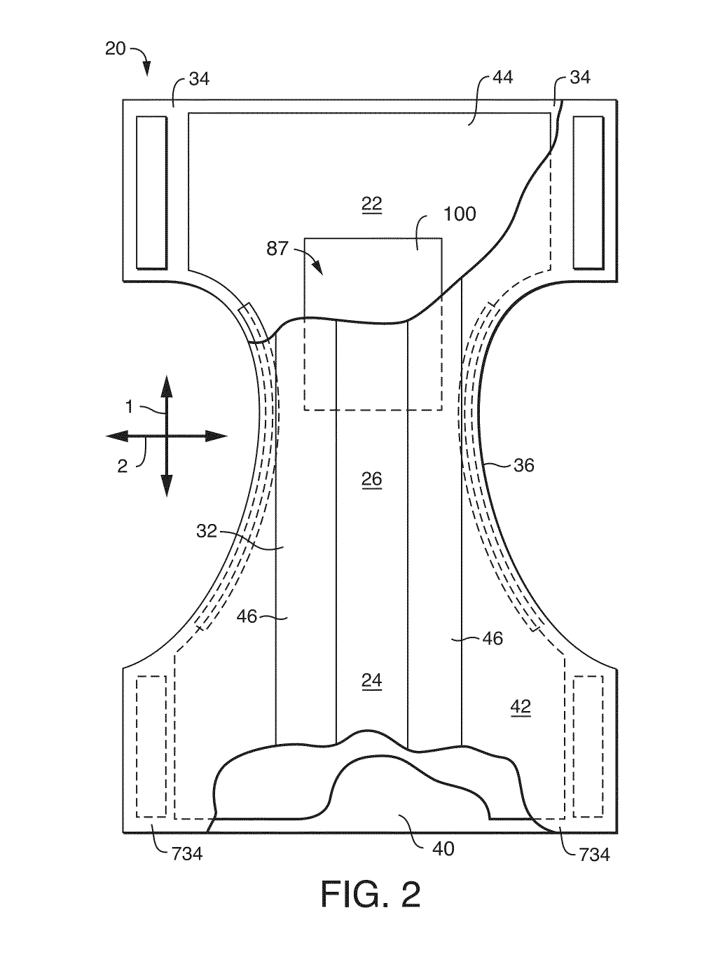

Typically, absorbent articles include a substantially liquid-impermeable layer (e.g., outer cover or backsheet), a liquid-permeable layer (e.g., bodyside liner or topsheet, surge layer, etc.), and an absorbent core. The absorbent core can be disposed between the topsheet and the backsheet. To gain a better understanding of the present invention, attention is directed to FIGS. 1 and 2 for exemplary purposes showing a training pant and a signal composite of the present invention.

Various materials and methods for constructing training pants are disclosed in U.S. Pat. No. 6,761,711 to Fletcher et al.; U.S. Pat. No. 4,940,464 to Van Compel et al.; U.S. Pat. No. 5,766,389 to Brandon et al., and U.S. Pat. No. 6,645,190 to Olson et al., each of which is incorporated herein by reference in a manner that is consistent herewith.

FIG. 1 illustrates a training pant 20 in a partially fastened condition, and FIG. 2 illustrates a training pant 20 in an opened and unfolded state. The training pant 20 defines a longitudinal direction 1 that extends from the front of the training pant when worn to the back of the training pant. Perpendicular to the longitudinal direction 1 is a lateral direction 2.

The training pant 20 defines a front region 22, a back region 24, and a crotch region 26 extending longitudinally between and interconnecting the front and back regions. The pant 20 also defines an inner surface (i.e., body-facing surface) adapted in use (e.g., positioned relative to the other components of the pant) to be disposed toward the wearer, and an outer surface (i.e., garment-facing surface) opposite the inner surface. The training pant 20 has a pair of laterally opposite side edges and a pair of longitudinally opposite waist edges.

The illustrated pant 20 may include a chassis 32, a pair of laterally opposite front side panels 34 extending laterally outward at the front region 22 and a pair of laterally opposite back side panels 734 extending laterally outward at the back region 24. The pant 20 further includes a sensor 100 that is placed, for example, between the absorbent core 44 and the topsheet 42 so that the sensor surface 87 is revealed from the inside of the pant 20. In an alternative (not shown), the sensor 100 is located between the backsheet 40 and the absorbent core 44 so that it may be viewed through the backsheet. Sensor 100 may be located anywhere on the absorbent article where wetness sensing is desired.

The chassis 32 includes a backsheet 40 and a topsheet 42 that may be joined to the backsheet 40 in a superimposed relation therewith by adhesives, ultrasonic bonds, thermal bonds or other conventional techniques. The chassis 32 may further include an absorbent core 44 such as shown in FIG. 2 disposed between the backsheet 40 and the topsheet 42 for absorbing fluid body exudates exuded by the wearer, and may further include a pair of containment flaps 46 secured to the topsheet 42 or the absorbent core 44 for inhibiting the lateral flow of body exudates.

The backsheet 40, the topsheet 42 and the absorbent core 44 may be made from many different materials known to those skilled in the art. The backsheet 40 may be constructed of a nonwoven material. The backsheet 40, may be a single layer of a fluid impermeable material, or alternatively may be a multi-layered laminate structure in which at least one of the layers is fluid impermeable.

Examples of suitable backsheet 40 materials are spunbond-meltblown fabrics, spunbond-meltblown-spunbond fabrics, spunbond fabrics, or laminates of such fabrics with films, or other nonwoven webs; elastomeric materials that may include cast or blown films, meltblown fabrics or spunbond fabrics composed of polyethylene, polypropylene, or polyolefin elastomers, as well as combinations thereof. The backsheet 40 may include materials that have elastomeric properties through a mechanical process, printing process, heating process or chemical treatment. For example, such materials may be apertured, creped, neck-stretched, heat activated, embossed, and micro-strained, and may be in the form of films, webs, and laminates.

One example of a suitable material for a biaxially stretchable backsheet 40 is a breathable elastic film/nonwoven laminate, such as described in U.S. Pat. No. 5,883,028, to Morman et al., incorporated herein by reference in a manner that is consistent herewith. Examples of materials having two-way stretchability and retractability are disclosed in U.S. Pat. No. 5,116,662 to Morman and U.S. Pat. No. 5,114,781 to Morman, each of which is incorporated herein by reference in a manner that is consistent herewith.

The topsheet 42 is suitably compliant, soft-feeling and non-irritating to the wearer's skin. The topsheet 42 is also sufficiently liquid permeable to permit liquid body exudates to readily penetrate through its thickness to the absorbent core 44. A suitable topsheet 42 may be manufactured from a wide selection of web materials, such as porous foams, reticulated foams, apertured plastic films, woven and non-woven webs, or a combination of any such materials. For example, the topsheet 42 may include a meltblown web, a spunbonded web, or a bonded-carded-web composed of natural fibers, synthetic fibers or combinations thereof. The topsheet 42 may be composed of a substantially hydrophobic material, and the hydrophobic material may optionally be treated with a surfactant or otherwise processed to impart a desired level of wettability and hydrophilicity.

The topsheet 42 may also be extensible and/or elastomerically extensible. Suitable elastomeric materials for construction of the topsheet 42 can include elastic strands, LYCRA elastics, cast or blown elastic films, nonwoven elastic webs, meltblown or spunbond elastomeric fibrous webs, as well as combinations thereof. Examples of suitable elastomeric materials include KRATON elastomers, HYTREL elastomers, ESTANE elastomeric polyurethanes (available from Noveon, a business having offices located in Cleveland, Ohio U.S.A.), or PEBAX elastomers. The topsheet 42 can also be made from extensible materials such as those described in U.S. Pat. No. 6,552,245 to Roessler et al. which is incorporated herein by reference in a manner that is consistent herewith. The topsheet 42 can also be made from biaxially stretchable materials as described in U.S. Pat. No. 6,969,378 to Vukos et al. which is incorporated herein by reference in a manner that is consistent herewith.

The article 20 can optionally further include a surge management layer which may be located adjacent the absorbent core 44 and attached to various components in the article 20 such as the absorbent core 44 or the topsheet 42 by methods known in the art, such as by using an adhesive. Examples of suitable surge management layers are described in U.S. Pat. No. 5,486,166 to Bishop et al.; U.S. Pat. No. 5,490,846 to Ellis et al.; and U.S. Pat. No. 5,820,973 to Dodge et al., each of which is incorporated herein by reference in a manner that is consistent herewith.

The article 20 can further comprise an absorbent core 44. The absorbent core 44 may have any of a number of shapes. For example, it may have a 2-dimensional or 3-dimensional configuration, and may be rectangular shaped, triangular shaped, oval shaped, race-track shaped, I-shaped, generally hourglass shaped, T-shaped and the like. It is often suitable for the absorbent core 44 to be narrower in the crotch portion 26 than in the rear 24 or front 22 portion(s). The absorbent core 44 can be attached in an absorbent article, such as to the backsheet 40 and/or the topsheet 42 for example, by bonding means known in the art, such as ultrasonic, pressure, adhesive, aperturing, heat, sewing thread or strand, autogenous or self-adhering, hook-and-loop, or any combination thereof.

The absorbent core 44 can be formed using methods known in the art. While not being limited to the specific method of manufacture, the absorbent core can utilize forming drum systems, for example, see U.S. Pat. No. 4,666,647 to Enloe et al., U.S. Pat. No. 4,761,258 to Enloe, U.S. Pat. No. 6,630,088 to Venturino et al., and U.S. Pat. No. 6,330,735 to Hahn et al., each of which is incorporated herein by reference in a manner that is consistent herewith. Examples of techniques which can introduce a selected quantity of optional superabsorbent particles into a forming chamber are described in U.S. Pat. No. 4,927,582 to Bryson and U.S. Pat. No. 6,416,697 to Venturino et al., each of which is incorporated herein by reference in a manner that is consistent herewith.

In some desirable aspects, the absorbent core includes cellulose fiber and/or synthetic fiber, such as meltblown fiber, for example. Thus, in some aspects, a meltblown process can be utilized, such as to form the absorbent core in a coform line. In some aspects, the absorbent core 44 can have a significant amount of stretchability.

The absorbent core 44 can additionally or alternatively include absorbent and/or superabsorbent material. Accordingly, the absorbent core 44 can comprise a quantity of superabsorbent material and optionally fluff contained within a matrix of fibers. In some aspects, the total amount of superabsorbent material in the absorbent core 44 can be at least about 10% by weight of the core, such as at least about 30%, or at least about 60% by weight or at least about 90%, or between about 10% and about 98% by weight of the core, or between about 30% to about 90% by weight of the core to provide improved benefits. Optionally, the amount of superabsorbent material can be at least about 95% by weight of the core, such as up to 100% by weight of the core. In other aspects, the amount of absorbent fiber of the present invention in the absorbent core 44 can be at least about 5% by weight of the core, such as at least about 30%, or at least about 50% by weight of the core, or between about 5% and 90%, such as between about 10% and 70% or between 10% and 50% by weight of the core. In still other aspects, the absorbent core 44 can optionally comprise about 35% or less by weight unmodified fluff, such as about 20% or less, or 10% or less by weight unmodified fluff.

It should be understood that the absorbent core 44 is not restricted to use with superabsorbent material and optionally fluff. In some aspects, the absorbent core 44 may additionally include materials such as surfactants, ion exchange resin particles, moisturizers, emollients, perfumes, fluid modifiers, odor control additives, and the like, and combinations thereof. In addition, the absorbent core 44 can include foam.

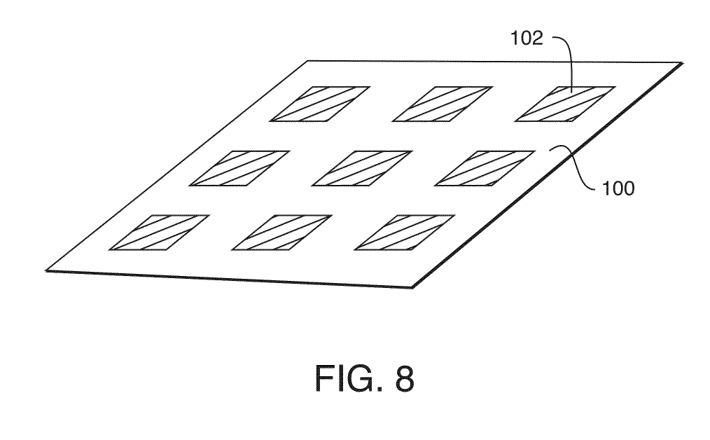

An example of a substrate of the present disclosure is depicted in FIG. 8. The substrate 100 has an indicia 102 printed thereon using the color-change composition.

### (C)

### Empirical Data

The present disclosure can be better understood with reference to the following empirical examples.

Ink #1: Into about 16 ml of ethanol, added was about 0.8 ml benzyltrimethyl ammonium hydroxide 40 wt % in water solution, 2.25 g Luviquat Supreme and 40 mg Basic Fuchsin. The resulting ink was applied onto a clear polypropylene film and appeared to be colorless, after drying under ambient, air open conditions. The ink was prepared and tested as described in the Procedure section. When exposed to the acidic volatile, the printed color pattern turned a red color.

Ink #2: Into about 16 ml of ethanol, added was about 0.8 ml benzyltrimethyl ammonium hydroxide 40 wt % in water solution, 2.25 g Luviquat Supreme and 40 mg Brilliant Blue G. A reddish ink solution was formed. The resulting ink was applied onto a clear polypropylene film and appeared to be red color, after drying under ambient, air open conditions. The ink was prepared and tested as described in the Procedure section. When exposed to the acidic volatile, the printed color pattern turned a blue color.

Ink #3: Into about 16 ml of ethanol, added was about 0.8 ml benzyltrimethyl ammonium hydroxide 40 wt % in water solution, 2.25 g Luviquat Supreme and 40 mg Cresol Red. A blue ink solution was formed. The resulting ink was applied onto a clear polypropylene film and appeared to be blue color, after drying under ambient, air open conditions. The ink was prepared and tested as described in the Procedure section. When exposed to the acidic volatile, the printed color pattern turned a yellow color.

Ink #4: Into about 16 ml of ethanol, added was about 0.8 ml benzyltrimethyl ammonium hydroxide 40 wt % in water solution, 2.25 g Luviquat Supreme and 40 mg m-Cresol Purple. A blue ink solution was formed. The resulting ink was applied onto a clear polypropylene film and appeared to be blue in color, after drying under ambient, air open conditions. The ink was prepared and tested as described in the Procedure section. When exposed to the acidic volatile, the printed color pattern turned a yellow color.

Ink #5: Into about 16 ml of ethanol, added was about 0.8 ml benzyltrimethyl ammonium hydroxide 40 wt % in water solution, 2.25 g Luviquat Supreme and 40 mg Brilliant Blue R. A reddish ink solution was formed. The resulting ink was applied onto a clear polypropylene film and appeared to be colorless, after drying under ambient, air open conditions. The ink was prepared and tested as described in the Procedure section. When exposed to the acidic volatile, the printed color pattern turned a blue color.

Ink #6: Into about 16 ml of ethanol, added was about 0.8 ml benzyltrimethyl ammonium hydroxide 40 wt % in water solution, 2.25 g Luviquat Supreme and 40 mg Thymol Blue. A blue ink solution was formed. The resulting ink was applied onto a clear polypropylene film and appeared to be blue in color, after drying under ambient, air open conditions. The ink was prepared and tested as described in the Procedure section. When exposing to acidic volatile, the printed color pattern turned a yellow color.

Ink #7: Into about 16 ml of ethanol, added was about 0.8 ml benzyltrimethyl ammonium hydroxide 40 wt % in water solution, 2.25 g VINNAPAS EZ123 and 40 mg m-Cresol Purple. A blue ink solution was formed. The resulting ink was applied onto a clear polypropylene film and appeared to be blue in color, after drying under ambient, air open conditions. The ink was prepared and tested as described in the Procedure section. When exposed to the acidic volatile, the printed color pattern turned a yellow color.

Ink #8: Into about 16 ml of ethanol, added was about 0.8 ml benzyltrimethyl ammonium hydroxide 40 wt % in water solution, 2.25 g VINNAPAS EZ123 and 40 mg Brilliant Blue G. A blue ink solution was formed. The resulting ink was applied onto a clear polypropylene film and appeared to be red in color, after drying under ambient, air open conditions. The ink was prepared and tested as described in the Procedure section. When exposed to the acidic volatile, the printed color pattern turned a blue color.

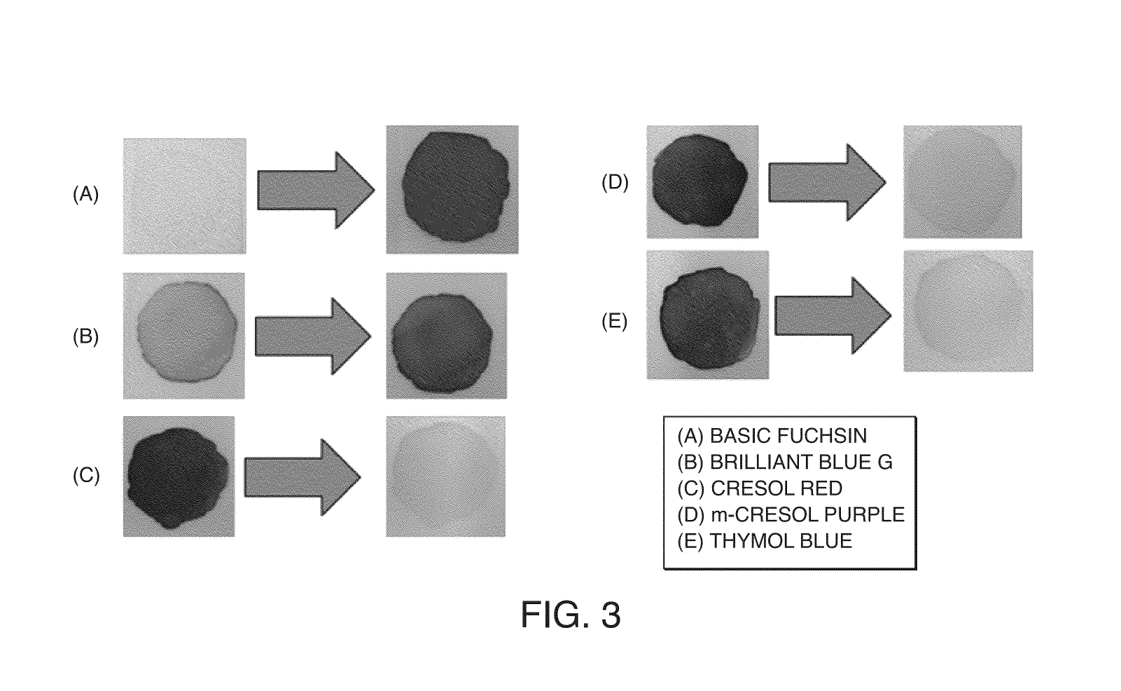

The success criterion for a dye was a response to 50 ppm of acetic acid volatiles in less than 10 minutes. Six dyes performed successfully: Basic Fuchsin, Brilliant Blue G, Cresol Red, m-Cresol Purple, Brilliant Blue R and Thymol Blue. Upon exposure to the acetic acid volatiles, these dyes displayed noticeable color changes such as red to blue and blue to yellow. FIG. 3 depicts the color change for several of the dyes. FIG. 4 depicts the ΔE for the eight dyes at various concentrations of volatiles. When comparing the color-change intensity, it is noted that a ΔE* of approximately 3 is the threshold of a visually-detectable difference in color.

Ink #7 and Ink #8 were tested with real BM and urine as described in the TEST METHOD—Bench Testing with BM and Urine. Ink #7 displayed noticeable color changes, blue to yellow, when exposed to BM volatiles, while it did not display color changes when exposed to urine volatiles. This ink formulation can be used as a BM indicator in an absorbent product. Ink #8 displayed noticeable and rapid color changes (within 1 minute), red to blue, when exposed to both BM volatiles and urine volatiles. Ink #8 could be used as a change indicator in an absorbent product.

### Procedures:

### Ink Preparation

Specific ink formulations can be found in the Empirical Data section above. Each ingredient was weighed in a 20 mL glass vial using a Scientech SA 210D scale. The ingredients were combined. Each ink sample was sonicated for approximately two hours using a Cole Parmer 8891 sonicator. Samples were stored covered in aluminum foil and show optimal results if used within one week. Before preparing samples by applying the ink onto a clear polyethylene film (described below), ink was mixed for two minutes using a VWR digital vortex mixer.

### Sample Preparation

Samples were made by applying 8 μL of ink solution onto clear 2 mil polyethylene film (Berry Plastics Corporation, Evansville, Ind.) with a micropipette. Using tip of the micropipette, the ink was distributed across the film surface to form a circle with a 16 mm diameter. Samples were left out in ambient conditions to dry for sufficient time before testing. If overnight storage was required, the dried samples were stored in aluminum foil.

### Test Method—Gas Chamber

### Equipment

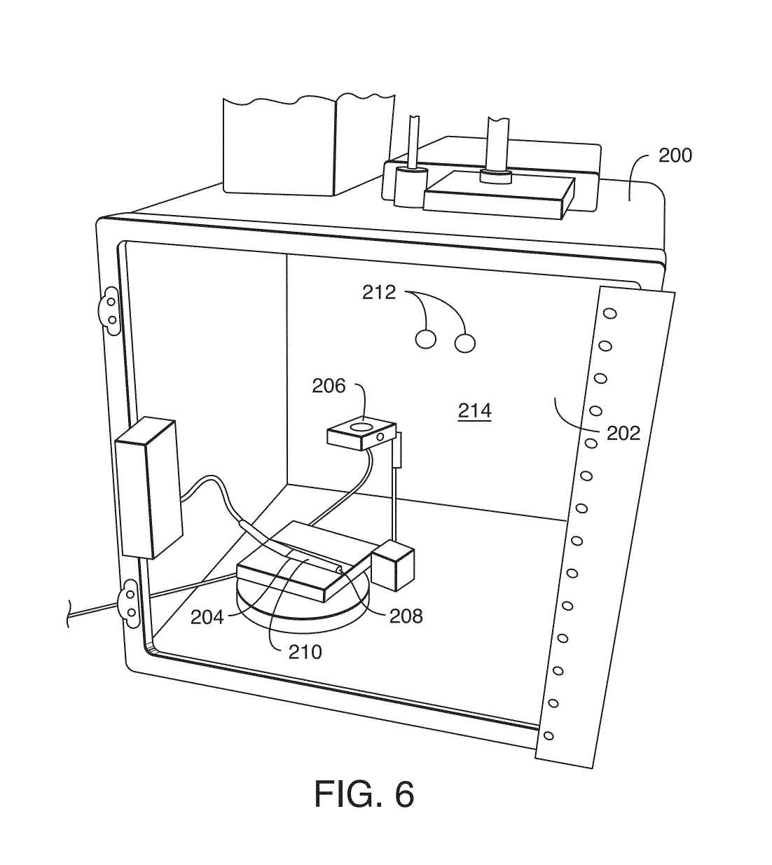

Referring to FIG. 6, a clear NALGENE acrylic desiccator cabinet is used as a test chamber (Model 5317-0120, available from Thermo Scientific, Waltham, Mass., USA). The cabinet 200 has an internal volume of about 23.1 liters. A cabinet door 202 has gaskets (not shown) to provide an air-tight seal. Inside cabinet 200, there is a heating element 204 (1″×3″ KAPTON Heater, model number KHLV-103/2 available from OMEGA Engineering, Inc., Stamford, Conn., USA) and a computer fan 206 that is used to circulate volatiles within cabinet 200. A power supply (not shown), used to control temperature generated by the heating element 204, is set at 29 Volts and 0.3 Ampere. A standard glass slide 208 is placed on top of the heating element 204. A piece of Whatman #4 filter paper 210, same shape as the heating element 204, is placed on top of the glass slide 208. A pre-determined amount of acetic acid solution is injected onto the prepared piece of Whatman #4 filter paper 210 to generate a desired concentration of acetic acid volatile in the cabinet 200. After each test is complete, this filter paper 210 is replaced and the door 202 opened to let gases clear out of the cabinet 200 before beginning another test.

### Procedures

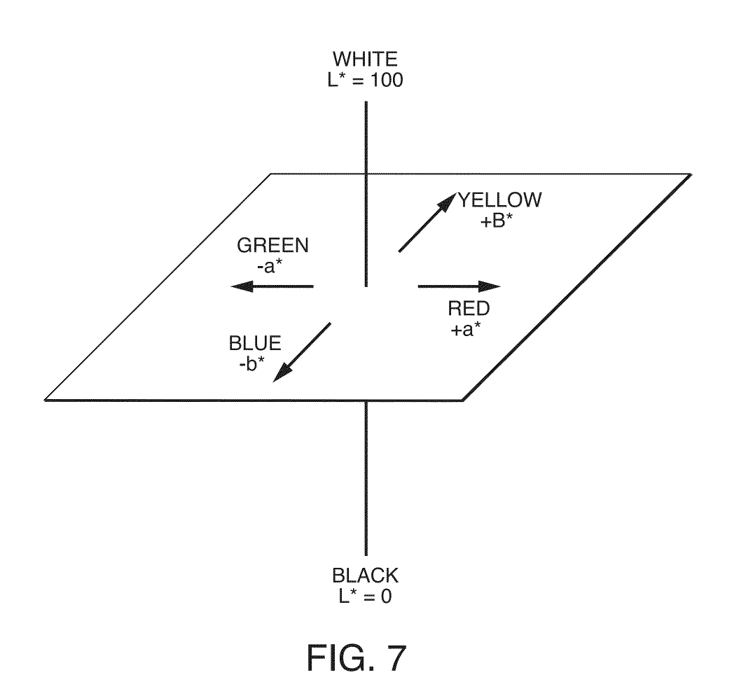

Using a SPECTRO-GUIDE spectrophotometer (available from BYK-Gardner USA located in Columbia, Md.), record L*, a*, and b* values for two indicator samples according to a CIELAB color scale. [The CIELAB color scale is an approximately uniform color scale. Referring to FIG. 7 in a uniform color scale, the differences between points plotted in the color space correspond to visual differences between the colors plotted. The CIELAB color space is organized in a cube form. The L* axis runs from top to bottom. The maximum for L* is 100, which represents a perfect reflecting diffuser. The minimum for L* is zero, which represents black. The a* and b* axes have no specific numerical limits. Positive a* is red. Negative a* is green. Positive b* is yellow. Negative b* is blue.]

Tape the two indicator samples 212 to the back wall 214 of the cabinet 200 in a spaced apart configuration so that the ink side faces the interior of the test chamber. Inject each sample 212 with 23.6 microliter of acetic acid solution (2M). Close the cabinet door 202 immediately thereafter. Immediately activate the heating element 204, fan 206 and a timer (not shown).

$$\begin{matrix}{c}_{acid} ( ppm ) = \frac{{n}_{acid} ( mole )}{{n}_{air} ( mole )} \times {10}^{6} \\ = \frac{{n}_{acid} ( mole )}{\frac{P \cdot V}{R \cdot T}} \times {10}^{6}\end{matrix}$$

$$\begin{matrix}{c}_{acid} ( ppm ) = \frac{\begin{matrix}( 2 mol \cdot {L}^{- 1} \times 23.6 \cdot {10}^{- 6} L ) \times \\ ( 0.08206 atm \cdot L \cdot {mol}^{- 1} \cdot {K}^{- 1} ) \times ( 298 K )\end{matrix}}{( 1 atm ) \times ( 23.1 L )} \times {10}^{6} \\ = 50\end{matrix}$$

Remove the samples 212 from the cabinet 200 after 10 minutes.

Visually monitor the two samples 212. For each sample, record the approximate time when it has completely changed color. Round this time up to the nearest half-minute.

Color change intensity is calculated. Using a SPECTRO-GUIDE spectrophotometer (available from BYK-Gardner USA located in Columbia, Md.), record L*, a*, and b* values for each indicator sample. The color change intensity (ΔE*) is calculated with this formula:

ΔE*=\sqrt{(L*₁−L*₂)²+(a*₁−a*₂)²+(b*₁−b*₂)²}

Test Method—Bench Testing with BM and Urine

BM and urine samples were collected from HUGGIES brand Step 1 diaper users and stored in a refrigerator. Ink #7 and Ink #8 samples were tested using 1-2 day old, individual BM samples heated to 39° C. Urine samples from different babies were combined, heated to 39° C., and 10 mL was used for each sample. BM or urine samples were placed in 4 oz. plastic specimen jar. Indicator samples were taped to a clear plastic film and placed on top of each jar. Pictures of indicator samples were taken every minute until the indicator visually changed color. Response times were recorded.

It should be understood, of course, that the foregoing relates only to certain disclosed embodiments of the present invention and that numerous modifications or alterations may be made therein without departing from the spirit and scope of the invention as set forth in the appended claims.

What is claimed:

1. A color-change composition for the detection of urine or feces volatiles, the composition comprising:
a dye selected from the group consisting of m-Cresol Purple, Basic Fuchsin, Brilliant Blue G, Brilliant Blue R, Cresol Red and Thymol Blue, and combinations thereof;
a film former; and
a solvent;
wherein the dye is 0.01% to 10% of the total weight of the composition, and the film former is 3% to 50% of the total weight of the composition.

2. The color-change composition of claim 1 wherein the dye consists of Basic Fuchsin.

3. The color-change composition of claim 1 wherein the dye consists of m-Cresol purple.

4. The color-change composition of claim 1 wherein the dye consists of Brilliant Blue G.

5. The color change composition of claim 1 wherein the dye is 0.1% to 2% by weight of the composition.

6. The color change composition of claim 1 further comprising a pH adjuster.

7. The color change composition of claim 1 further comprising a surfactant.

8. An absorbent article for detecting volatiles from human waste, the article comprising:
an absorbent core disposed between a topsheet and a backsheet, and a color-change composition disposed on a garment-facing surface of the backsheet, the color change composition comprising,
a dye selected from the group consisting of m-Cresol Purple, Basic Fuchsin, Brilliant Blue G, Brilliant Blue R, Cresol Red and Thymol Blue, and combinations thereof;
a film former; and
a pH adjuster.

9. The absorbent article of claim 8 wherein the dye consists of Brilliant Blue G.

10. The absorbent article of claim 8 wherein the dye consists of m-Cresol Purple.

11. A substrate for detecting urine or feces volatiles, the substrate comprising:
a sheet or web with a color-change composition disposed thereon, the composition comprising a dye selected from the group consisting of m-Cresol Purple, Basic Fuchsin, Brilliant Blue G, Brilliant Blue R, Cresol Red and Thymol Blue, and combinations thereof; and a film former.

12. The substrate of claim 11 wherein the composition is applied to a garment-facing surface.

13. The substrate of claim 11 wherein the composition is applied in a configuration comprising letters, numbers, graphics or any combination thereof.

14. The substrate of claim 11 wherein the sheet or web comprises a nonwoven material.

15. The substrate of claim 11 wherein the sheet or web comprises a polyolefin film.
